(19) United States
(12) Patent Application Publication
(10) Pub. No.: US 2009/0158844 A1
(43) Pub. Date: Jun. 25, 2009

(54) Kitchen bowl

(76) Inventors: Dean DiPietro, Brooklyn, NY (US); Peter Michaelian, Tappan, NY (US)

Correspondence Address: SEYFARTH SHAW LLP, 131 S. DEARBORN ST., SUITE 2400, CHICAGO, IL, 60603-5803, US

(21) Appl. No.: 12/004,596

(22) Filed: Dec. 21, 2007

(51) Int. Cl. G01F 19/00; B29C 45/16

(52) U.S. Cl. 73/427; 264/78

(57) ABSTRACT

A kitchen bowl is disclosed having a bowl portion formed of material with a first color, and indicia molded into a side of the bowl portion, the indicia having a second color that is different and contrasting to the first color, and the indicia being viewable on an interior of the kitchen bowl. Preferably, the bowl portion is molded with openings formed therein, and the openings are filled by a second molding step via injecting a different colored material into the openings. Preferably, the different colored materials are the same polymeric material with different colorants added thereto to provide contrast between the indicia and the bowl portion. The kitchen bowl may be provided with a handle, which may have a gripping surface thereon, and may be provided with a covering to provide a grip surface to the bottom, sides, or edges of the bowl portion.

### FIELD OF THE INVENTION

The invention relates to a kitchen bowl and, in particular, to a kitchen bowl having indicia on an interior surface designating volumetric measure and used for mixing foodstuffs.

### BACKGROUND

Currently, it is known to utilize a variety of devices for scooping, measuring, and combining or mixing quantities of bulk dry or fluid foodstuffs. Such foodstuffs may be generally anything, though it is usually contemplated that the foodstuffs are constituents of a mixture that is to be prepared as described by a recipe. As an example, ingredients such as flour, water, oil, eggs, baking soda, vanilla, etc., may all be constituents in various baked goods.

Of these devices, it is not uncommon to have graduated markings on either the interior or exterior surface of the device in order to assist in measuring the foodstuffs. That is, while some devices, such as a tablespoon measuring spoon, are simply designated as a discreet amount, others may have markings for a quarter-cup, a half-cup, three-quarters-cup, a full-cup, etc. For devices with markings on the exterior, the only practical utility is when the device itself is transparent (or, minimally, semi-translucent) so that the amount of foodstuff material within the device may be visible through a sidewall of the device and aligned with the graduated markings. Such transparent devices are most commonly used for measuring fluid of low viscosity or dry material, as highly viscous foodstuffs tend to stick to the interior sidewalls of the device making it difficult to determine where the top boundary (or lowest meniscus) is for the foodstuff.

There are basically two manners of presenting interior graduated markings on these devices. First of all, it should be noted that such markings require an angle of viewing in order to view accurately. Hence, interior markings are used more frequently on larger devices such as mixing bowls, or are typically used with a minimum of markings such as a measuring spoon having only markings for a full-tablespoon and a half-tablespoon. For both manners, the markings are often harshly treated by mixing devices or mixing action, such as the use of hand or electric beaters.

One of the manners is the printing of the markings on the interior surface. As a result of beating or mixing materials in the device, the printed markings are worn away quite easily, and the markings become part of the food being mixed.

The other manner for providing interior markings is by providing raised lettering or indicia. Again, these raised indicia are treated harshly by beating action. Also, while the printed markings have the advantage of being of a contrasting color, the raised indicia do not provide such benefit unless colorant is printed to the upper surface of the lettering; in this case, the printing is even more susceptible to wear.

Accordingly, there has been a need for an improved kitchen device provided with graduated markings for measuring foodstuffs.

### SUMMARY

In accordance with an aspect, a kitchen bowl is disclosed including a bowl portion for receiving foodstuffs therein, the bowl portion being formed of a first material having a first color, and the bowl portion having openings formed in a side portion thereof, the openings having edges at least partially defined as indicia to provide volumetric measure, and a molding portion including a second material having a second color, the first and second colors being visually distinct, wherein at least some of the molding portion is received within the bowl portion openings to form indicia seen from an interior side of the bowl portion.

In some forms, the first and second materials are formed of an identical material, the first material further including a first colorant, and the second material further including a second colorant different and visually distinct from the first colorant.

In some forms, the molding portion is molded into the bowl portion such that said some of the molding portion is molded into the openings. The molding of the molding portion into the bowl portion may bond the first and second materials. The first and second materials may be identical other than color, and the molding temperature of the molding portion during molding thereof may at least soften a boundary of the bowl portion therewith to bond the molding portion with the bowl portion.

In some forms, the molding portion is formed as a single injection including a body portion and each of the molding portion indicia.

In some forms, the kitchen bowl includes an overmold covering the molding portion and covering at least a portion of the exterior of the bowl portion. The overmold may provide at least a first grip surface. The overmold may provide a grip surface surface on at least one of a handle, a bottom surface of the bowl portion, a side portion of the bowl portion, or an edge portion of the bowl.

In some forms, the molding portion indicia and opening edges have a substantially smooth boundary along a bowl interior surface.

In another aspect, a method of forming a kitchen bowl having graduated markings on an interior surface thereof is disclosed, the method comprising the steps of forming openings in a side portion of a bowl portion of the kitchen bowl, the openings corresponding to volumetric measure, and the bowl portion being formed of a first material having a first color, providing a second material with a second color, and injecting the second material into the openings of the bowl portion.

In some forms, the method includes the steps of selecting a single material, providing the first color to a first quantity of the single material for use as the bowl portion, and providing the second color to a second quantity of the single material for use as the molding portion.

In some forms, the method includes the step of providing a single injection site for injecting the second material into the openings of the bowl portion.

In some forms, the method includes the step of providing a plurality of injection sites for injecting the second material into the openings of the bowl portion.

In some forms, the step of injecting the second material may include providing the second material with a temperature sufficient to bond the second material with the bowl portion. The step of injecting the second material may include utilizing the temperature of the second material being injected to at least soften a boundary portion of the bowl portion to bond the second material with the bowl portion.

The method may include the step of applying a covering to at least a portion of the bowl portion and the second material injected into the bowl portion. The step of applying a covering may include providing a gripping surface.

The method may include the step of securing a handle with the bowl portion.

The step of forming openings may include injecting the first material into a first mold to form the bowl portion. The step of injecting the second material may include providing a second mold, positioning the bowl portion with the openings in the second mold, and injecting the second material into the second mold.

### BRIEF DESCRIPTION OF THE DRAWINGS

In the Figures, FIG. 1 is a perspective view of a kitchen bowl of the present invention including a bowl portion, a molding portion, a handle portion, and an overmold portion;

FIG. 2 is a perspective view of the bowl portion of the kitchen bowl of FIG. 1 showing openings for graduated markings provided in a portion thereof;

FIG. 3 is a side elevational view of the bowl portion of FIG. 2;

FIG. 4 is a rear elevational view of the bowl portion of FIG. 2;

FIG. 5 is a perspective view of the rear of the bowl portion of FIG. 2;

FIG. 6 is a second perspective view of the rear of the bowl portion of FIG. 2 with the molding portion injected into the openings providing graduated markings and corresponding to FIG. 5;

FIG. 7 is a perspective view of the molding portion after formation with the bowl portion of FIG. 2;

FIG. 8 is a front elevation view of the molding portion of FIG. 7;

FIG. 9 is a side elevation view of the molding portion of FIG. 8;

FIGS. 10 and 11 are perspective views of the handle portion of FIG. 1;

FIG. 12 is a perspective view of the rear of the bowl portion with the handle portion secured therewith;

FIG. 13 is a perspective view of the rear of the bowl portion with the handle portion secured therewith and with the molding portion injected thereinto; and

FIGS. 14 and 15 are perspective views of the overmold when formed over the bowl portion, the handle portion, and the molding portion.

### DETAILED DESCRIPTION

Referring initially to FIG. 1, a kitchen bowl 10 is depicted having graduated markings 11 of a contrasting color molded as a part of a molding portion 12 into a bowl portion 14 having openings 16 formed therein. The kitchen bowl 10 further has a handle 18 secured with the bowl portion 14 and an overmold portion 20 providing a gripping surface for both manual manipulation and for holding against a stationary structure during use of the kitchen bowl 10. It should be noted that, while usage of the term “overmold” indicates formation by a molding process, as described herein the overmold portion 20 is essentially a cover portion and/or gripping portion that may be formed in any other manner, such as casting, for instance.

In the present form, the kitchen bowl 10 is a mixing or batter bowl such as would be used for receiving constituents described in a recipe, such as a baking or cooking recipe, the constituents being mixed therein. Towards this end, a series of graduated markings and indicia 22 are provided on an interior surface 30 of the kitchen bowl 10. As an example of usage, instructions of a recipe may prescribe pouring a specific amount of batter onto a pan, such as for a pancake, or in a cupped pan for muffins or cupcakes. The indicia 22, thus, may include lines and numbers that indicate dry or fluid measure, or both, or US or metric units, or both, or any other combination that indicates quantity or volumetric measure.

As will be described, the indicia 22 are preferably formed directly into the bowl portion 14. This allows the indicia 22 and interior surface 30 to be nearly smooth, having very little if any surface feature that resists or is abraded by mixing of the constituents when the kitchen bowl 10 is used. It is noted that a finger may be sufficiently sensitive to detect the surface feature.

Additionally, the indicia 22 are formed with a first color 22a while the bowl portion 14 is formed with a second color 14a so that the indicia 22 present a contrast to the bowl portion 14, and to do so in a manner that will not be worn away by washing or by use. That is, the first and second colors 22a, 14a, are visually distinct so that the indicia 22 are easy to see in contrast. Additionally, it is preferred that the molding portion 12 is formed of the first material with a bright/dark color 22a, while the bowl portion 14 is formed of a second material having highly contrasting color 14a so that the indicia 22 may be seen somewhat through foodstuff that may be thereon, such as a thin layer of batter. For example, the color 14a of the bowl portion 14 may be white, while the indicia color 22a may be red. As discussed herein, the first and second materials of the molding portion 12 and bowl portion 14 are preferably the same polymeric material, but with different colorant.

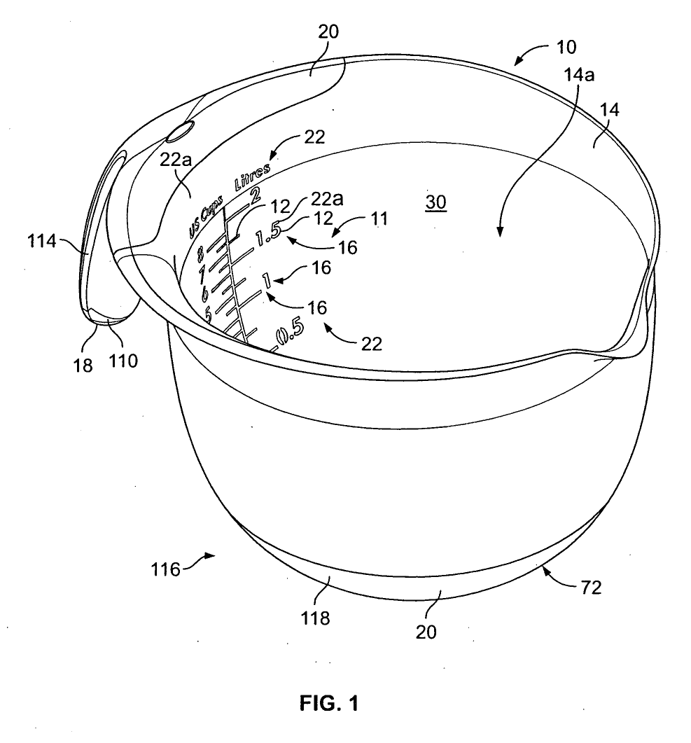

FIG. 2 solely illustrates the bowl portion 14. The bowl portion 14 is preferably formed by injection molding in a mold (not shown) that forms openings 16 in a rear area 34 of the bowl portion 14. The bowl portion 14 includes a fluted or outwardly splayed lip 36 around and defining a top edge 38. A front section 40 of the lip 36 includes a pouring spout 42, while a rear section 44 provides a number of structural features for mounting and molding other components of the kitchen bowl 10 thereto.

As can be seen, the rear section 44 includes a rearwardly extending portion 46 that forms a shoulder 48 with the lip 36 in general. The rearwardly extending portion 46 also has a opening 94 (discussed below) for securing the handle 18 therewith, as will be described in greater detail below.

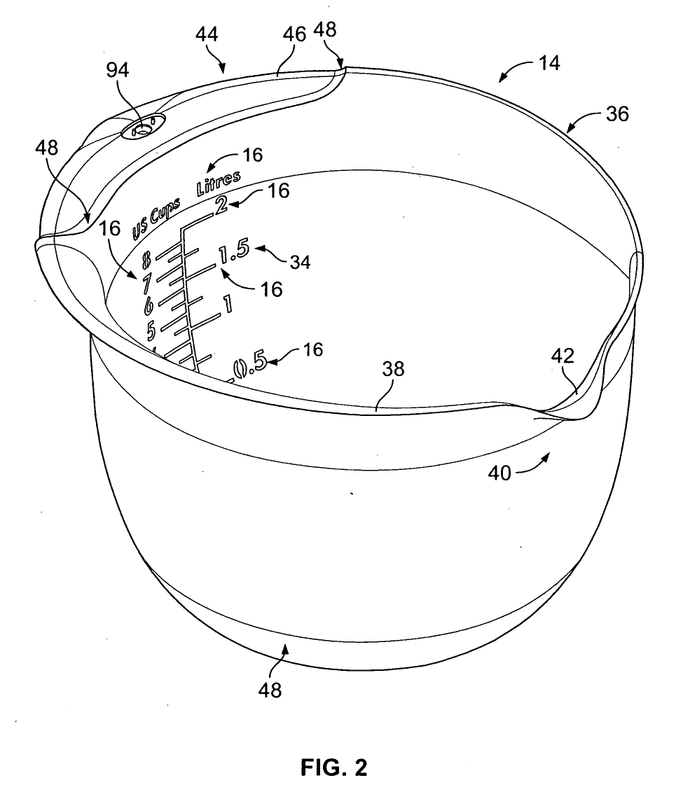

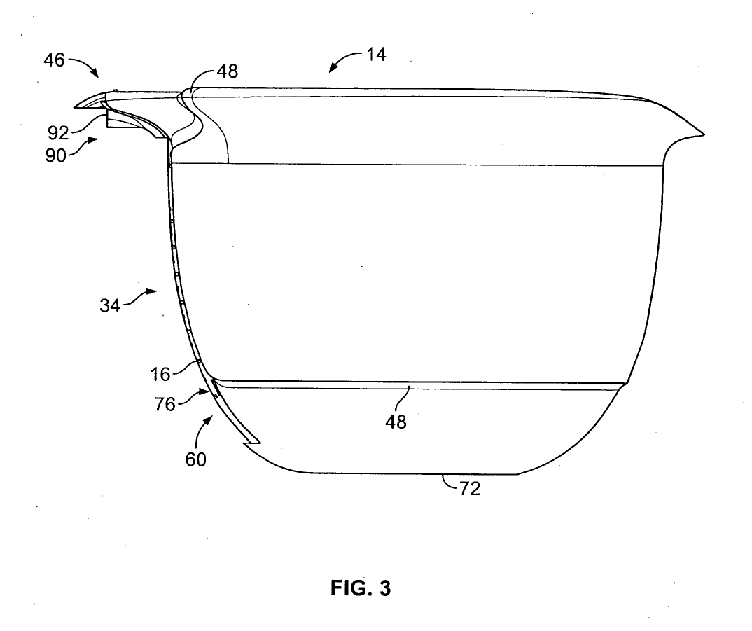

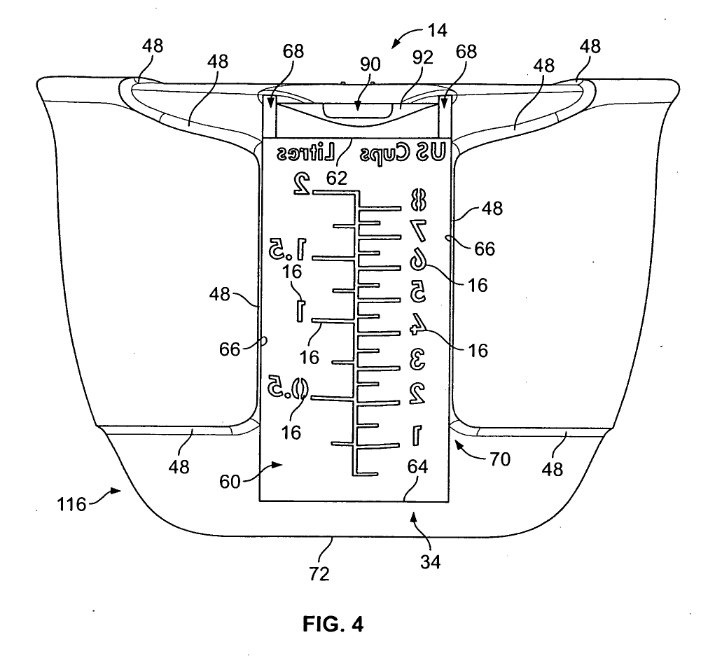

Turning now to FIGS. 3-5, it can be seen that the shoulder 48 shown in FIG. 2 extends around the rearwardly extending portion 46 and downwardly along the rear area 34. The rear area 34 of the bowl portion 14 includes a recess 60 for receiving the molding portion 12. The recess 60, as shown in FIG. 5, has a reverse-S shape including a recess upper shoulder 62, a recess lower shoulder 64, and respective recess side shoulders 66. By virtue of the openings 16 formed in the bowl portion 12, prior to molding of the molding portion 12 (to be discussed), the recess 60 is in communication to the interior space of the bowl portion 12. As can be seen, the bowl portion 14 includes a pair of channels 68 formed just above the recess upper shoulder 62: when formed with the bowl portion 14, the molding portion 12 generally fills the openings 16, fills the recess 60, and fills the channels 68. As can be seen best in FIGS. 4 and 5, the recess side shoulders 66 are generally aligned and coincident with the shoulder 48 extending along the rear area 34.

As can also be seen in FIGS. 3-5, the shoulder 48 continues to a point 70 above a bottom surface 72 of the bowl portion 14, and then extends generally horizontally around the exterior surface 74 of the bowl portion 14. More specifically, the overmold portion 20 is to be applied to the bowl portion 14 so that it abuts the shoulder 48. One of the advantages of the overmold portion 20 is to provide a gripping surface for assisting in immobilizing the kitchen bowl 10 during use. That is, the overmold portion 20 is preferably formed of a rubber material such as Santoprene®, and the kitchen bowl 10 may be pressed against a surface (such as a kitchen counter) during use so that the overmold portion 20 grips the surface and frictionally restricts movement of the kitchen bowl 10.

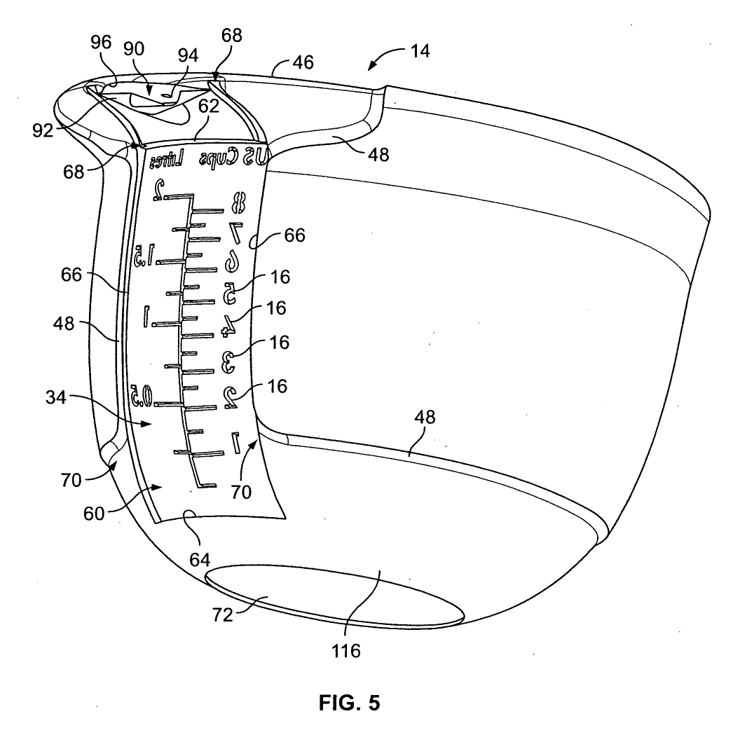

While FIG. 5 depicts the bowl portion 14 alone, FIG. 6 is a similar view of the bowl portion 16 though with the molding portion 16 formed therein. As has been noted, the bowl portion 16 is preferably first injection molded, which includes forming the openings 16 therein. The next step (other than removing sprues, etc.) is to place the bowl portion 14 in a second mold (not shown) having a section received along the interior surface 30 of the bowl portion 14. As the molding portion 12 is injected into the recess 60 and the openings 16, the described second mold section on the interior surface 30 allows the molding portion 12 in the openings 16 to form a generally smooth and contiguous surface, with minimal distortion, with the bowl portion interior surface 30.

Preferably, the molding portion 12 and the bowl portion 14 are formed of the same polymeric material. Accordingly, the cooling shrinkage is controlled. Additionally, the molding portion 12 is able to flow at a temperature which causes a slight amount of softening or melting at the interface between the molding portion 12 and the bowl portion 14 within the openings 16 so that the molding portion 12 and bowl portion 14 essentially become bonded or melted together. This not only reduces if not eliminates separation between the molding portion 12 and bowl portion 14, it generally eliminates the possibility of foodstuffs from becoming entrapped within said interface. Accordingly, the bowl portion 14 and the molding portion 12 may be formed by selecting a single material, allotting first and second quantities of the single material to the bowl portion 14 and the molding portion 12, respectively, and coloring each quantity with separate colors. It should be noted that sizing of the openings 16 should be selected in consideration of high flow temperature of the molding portion 12 so that the openings 16 do not become significantly distorted during the injection process.

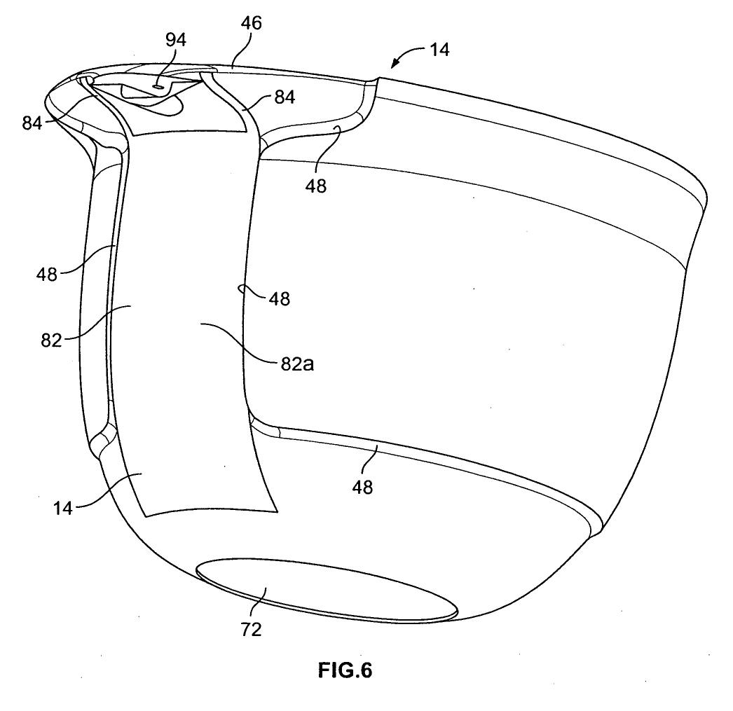

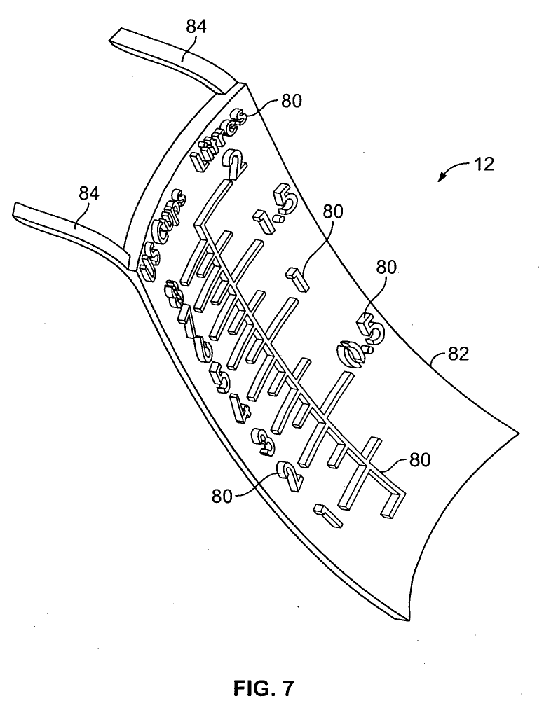

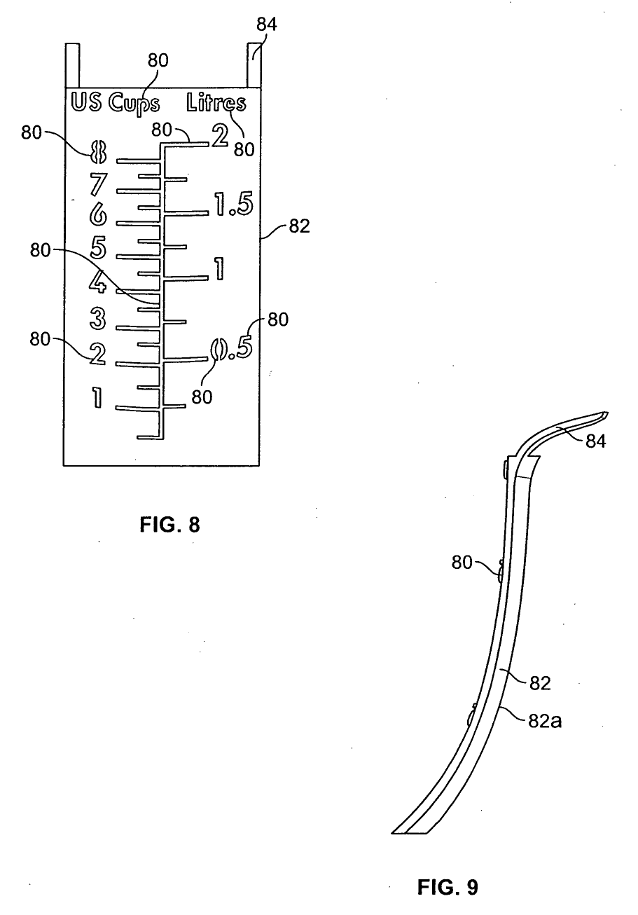

Turning to FIGS. 7-9, the molding portion 12 is illustrated. It should be noted that the molding portion 12 melts and bonds with the interface boundary of the bowl portion 14. Accordingly, the molding portion 12 of FIGS. 7-9 could not easily be separated from the bowl portion 14, if at all, and these FIGS. 7-9 are merely for illustrative purposes. As can be seen, the molding portion 12 includes raised indicia 80 which are formed within the openings 16, includes a molding body section 82 having a reverse-S shape to match the previously-described reverse-S shape of the recess 60 and a curved back side 82a to follow, though recessed from (see FIG. 6), the curvature of the bowl portion, and includes upper arm portions 84 formed in the channels 68 (see FIGS. 4 and 5). Injection of the molding portion 12 allows material to flow throughout a defined space in the mold (not show) so that the body section 82 and indicia 80, as well as the upper arm portions 84, are all formed from a single mold. This construction promotes flow of the material of the molding portion 14, simplifies temperature control of the material as it is injected into the openings 16, and allows use of a single injecting for all of the indicia 80. Alternatively, a plurality of injections could be utilized at a plurality of injection sites to inject the material of the molding portion 14 into the openings 16 to form the indicia 80 therewithin.

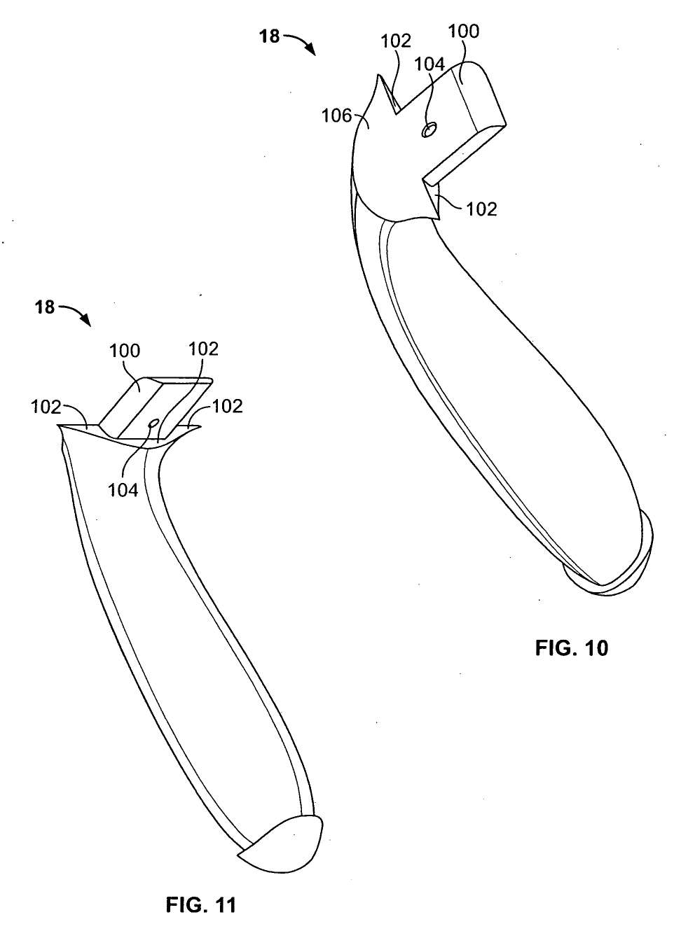

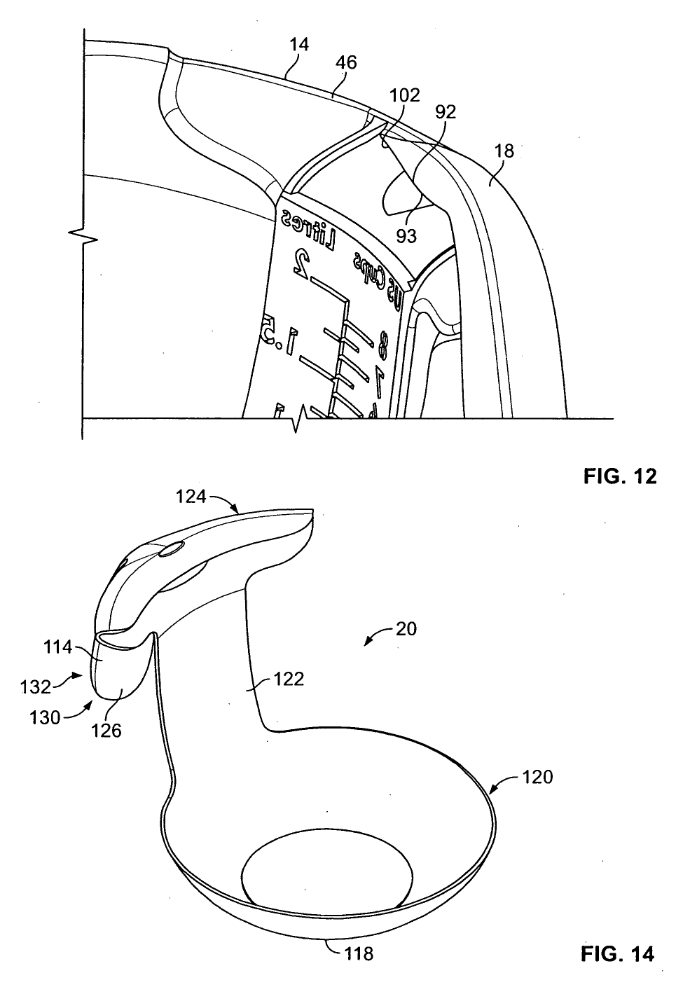

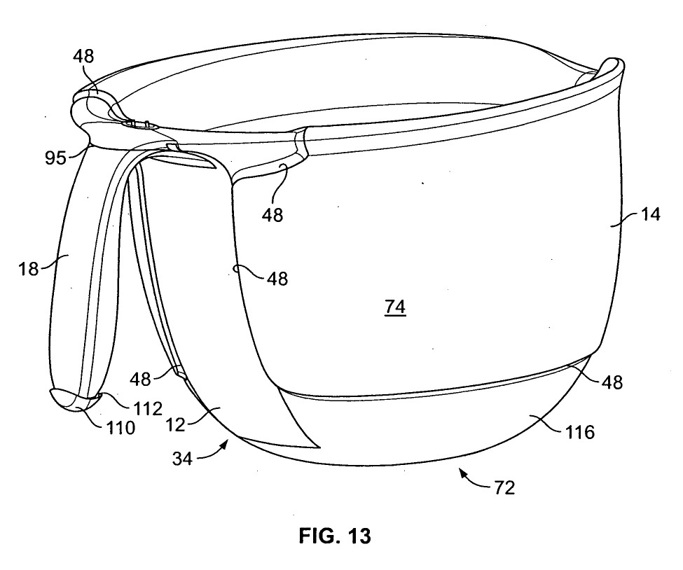

As noted above, the kitchen bowl 10 includes a handle 18 secured with the bowl portion 14, the handle 18 being depicted in FIGS. 10 and 11. Preferably, the handle 18 is secured with the bowl portion 14 after the molding portion 12 has been formed with the bowl portion 14 as such forming is simpler without the handle 18 having been secured. Referring again to FIGS. 3-5 and 10-11, structure for mating and between the bowl portion 14 and the handle 18 can be seen. A recess slot 90 is formed in the bowl portion 14 for receiving a tongue 100 of the handle 18, and the slot 90 and tongue 100 preferably have generally mating shapes so that a slight frictional fit, with minimal looseness or play, is formed therebetween. The tongue 100 is inserted into the slot 90 so that a shoulders or flat 102 formed laterally to and below the tongue 100 flushly abuts a flat 92 formed laterally to and below the slot 90. The tongue 100 includes an opening 104 that aligns with the opening 94 formed in the rearwardly extending portion 46 of the lip 36 so that a securing device (such as a screw, not shown) may be inserted therein to assist in retaining the handle tongue 100 within the slot 90, the flat 92 in abutment with the flat 102. FIGS. 12 and 13, which omit the molding portion 12 for illustrative purposes, illustrates the bowl portion 14 and handle 18 joined to provide smooth edges along flats 92, 102, and along an interface between a top surface 106 of the handle 18 (FIG. 10) and a bottom side 96 of the lip 36 (FIG. 5), as at 93 in FIG. 12 and as at 95 in FIG. 13.

Turning now to FIG. 13, the bowl portion 14, the molding portion 12 formed therewith, and the handle 18 secured to the bowl portion 14 are shown ready for receiving the overmold portion 20. As can be seen, the handle 18 has a lower portion 110 of enlarged size so as to form a shoulder 112. As noted previously, the shoulder 48 extends along a portion of the lip 36, specifically along a top portion of the lip 36, along the exterior surface 74 at the rear area 34 and around the exterior surface 74 in a generally horizontal manner separated from and above the bottom surface 72 of the bowl portion 14. The overmold portion 20 is applied to the assembly of FIG. 13 so as to form a layer that abuts the shoulder 48, and the handle shoulder 112. Thus, the overmold portion 20 provides the handle 18 with a grip surface 114, and provides the bottom surface 72 and a curved-edge portion 116 of the bowl portion 14 with a grip surface 118, also seen in FIGS. 1, 14, and 15. Towards this end, the overmold portion 20 is preferably a rubber material, as described above.

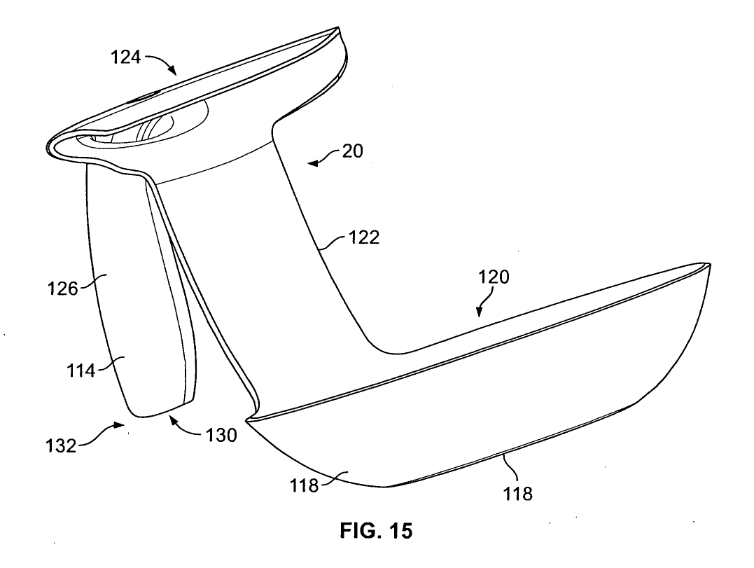

Again, being only formed onto the bowl portion 14 and handle 18 and molding portion 14, the overmold portion 20 generally is not to be separated from the other components of the kitchen bowl 10. For illustrative purposes only, the overmold portion 14, when formed, is illustrated as a sole component in FIGS. 14 and 15. As can be seen, the overmold portion 20 includes a cup-shaped bottom portion 120 received on the bowl portion bottom surface 72 and curved-edge portion 116 to provide the grip surface 118. The overmold portion 20 includes a back panel portion 122 that generally covers from view the molding portion 12 and fills in between portions of the shoulder 48 extending along the rear area 34. An upper portion 124 of the overmold portion 20, around the lip 36, covers the opening 94 in the lip 36 and the securing device (such as a screw) assisting in securing the handle 18 with the slot 90. A handle grip 126 generally covers the handle 18, above the shoulder 112, to provide the grip surface 114, and a hole 130 is formed in the lower portion 132 of the handle grip 126 such that the handle 18 extends therethrough, as can be seen in FIG. 1.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A kitchen bowl comprising:
a bowl portion for receiving foodstuffs therein, the bowl portion including:
a first material having a first color, and
openings formed in a side portion of the bowl portion, the openings having edges at least partially defined as indicia to provide volumetric measure; and
a molding portion including a second material having a second color, the first and second colors being visually distinct, wherein at least some of the molding portion is received within the bowl portion openings to form indicia seen from an interior side of the bowl portion.

2. The kitchen bowl of claim 1 wherein the first and second materials are formed of an identical material, the first material further including a first colorant, and the second material further including a second colorant different and visually distinct from the first colorant.

3. The kitchen bowl of claim 1 wherein the molding portion is molded into the bowl portion such that said some of the molding portion is molded into the openings.

4. The kitchen bowl of claim 3 wherein molding of the molding portion into the bowl portion bonds the first and second materials.

5. The kitchen bowl of claim 4 wherein the first and second materials are identical other than color, and the molding temperature of the molding portion during molding thereof at least softens a boundary of the bowl portion therewith to bond the molding portion with the bowl portion.

6. The kitchen bowl of claim 1 wherein the molding portion is formed as a single injection including a body portion and each of the molding portion indicia.

7. The kitchen bowl of claim 1 further including an overmold covering the molding portion and covering at least a portion of the exterior of the bowl portion.

8. The kitchen bowl of claim 7 wherein the overmold provides at least a first grip surface.

9. The kitchen bowl of claim 8 wherein the overmold provides a grip surface surface on at least one of a handle, a bottom surface of the bowl portion, a side portion of the bowl portion, or an edge portion of the bowl.

10. The kitchen bowl of claim 1 wherein the molding portion indicia and opening edges have a substantially smooth boundary along a bowl interior surface.

11. A method of forming a kitchen bowl having graduated markings on an interior surface thereof, the method comprising the steps of:
forming openings in a side portion of a bowl portion of the kitchen bowl, the openings corresponding to volumetric measure, and the bowl portion being formed of a first material having a first color;
providing a second material with a second color; and
injecting the second material into the openings of the bowl portion.

12. The method of claim 11 further including the steps of:
selecting a single material;
providing the first color to a first quantity of the single material for use as the bowl portion; and
providing the second color to a second quantity of the single material for use as the molding portion.

13. The method of claim 11 further including the step of providing a single injection site for injecting the second material into the openings of the bowl portion.

14. The method of claim 11 further including the step of providing a plurality of injection sites for injecting the second material into the openings of the bowl portion.

15. The method of claim 11 wherein the step of injecting the second material includes providing the second material with a temperature sufficient to bond the second material with the bowl portion.

16. The method of claim 15 wherein the step of injecting the second material includes utilizing the temperature of the second material being injected to at least soften a boundary portion of the bowl portion to bond the second material with the bowl portion.

17. The method of claim 11 further including the step of applying a covering to at least a portion of the bowl portion and the second material injected into the bowl portion.

18. The method of claim 17 wherein the step of applying a covering includes providing a gripping surface.

19. The method of claim 11 further including the step of securing a handle with the bowl portion.

20. The method of claim 11 wherein the step of forming openings includes injecting the first material into a first mold to form the bowl portion.

21. The method of claim 20 wherein the step injecting the second material includes:
providing a second mold;
positioning the bowl portion with the openings in the second mold; and
injecting the second material into the second mold.
